(19) United States
(12) Patent Application Publication
(10) Pub. No.: US 2003/0040987 A1
(43) Pub. Date: Feb. 27, 2003

(54) Global travel reporting system and method

(76) Inventors: K. Dean Hudson, Goodfield, IL (US); Gail E. Polonus, Peoria, IL (US)

Correspondence Address: Peter M. Lasorsa, Caterpillar Inc., Intellectual Property Department, AB6490, 100 N.E. Adams Street, Peoria, IL, 61629-6490, US

(21) Appl. No.: 09/811,003

(22) Filed: Mar. 16, 2001

Related U.S. Application Data
(60) Provisional application No. 60/205,975, filed on May 19, 2000.

(51) Int. Cl. G06F 17/60

(52) U.S. Cl. 705/30

(57) ABSTRACT

A global travel reporting system and method is disclosed, which includes at least one traveler client system in communication with a central database server system, a mainframe gateway server system in communication with a mainframe system and the central database server system, a corporate charge card provider in communication with the mainframe system to provide traveler charge card transaction data, a corporate banking provider in communication with the mainframe system for receiving payment direction, and the central database server system provides general ledger transaction processing, reimbursement processing, and payment processing and directs payment from the corporate bank provider to the corporate charge card provider.

### DESCRIPTION

1. Technical Field

The present invention relates to a method and system for global travel reporting and, more particularly, to an automated method and information system for supporting travel and expense book reporting.

2. Background Art

There is a current need for corporate global travel reporting that operates on a corporate database environment which allows automated travel reporting, specifically of travel and expense book reporting. Traditionally, corporate travel reporting systems combine manual and automated forms that require entry of repetitive data. More particularly, the entry, submittal, approval, auditing, and reimbursement of travel expenses is typically manual as well as routed manually and, in some cases, largely done through outside travel management firms rather than inside the corporation. These traditional systems, thus, are time-consuming, error-ridden, confusing, non-comprehensibly-informative, and overly expensive in addition to being non-judicious for a traveler, manager, and corporation in terms of approval, reimbursement, and accurate up-to-minute expense budget reporting. Accordingly, a need has arisen for a global travel reporting system which addresses these long-standing issues.

The present invention is directed to overcoming one or more of the problems set forth above.

### DISCLOSURE OF THE INVENTION

In one aspect of this invention, a global travel reporting system is disclosed. The system includes at least one traveler client system in communication with a central database server system, a mainframe gateway server system in communication with a mainframe system and the central database server system, a corporate charge card provider in communication with the mainframe system to provide traveler charge card transaction data, a corporate banking provider in communication with the mainframe system for receiving payment direction, and the central database server system provides general ledger transaction processing, reimbursement processing, and payment processing and directs payment from the corporate bank provider to the corporate charge card provider.

In another aspect of this invention, a method for global travel reporting is disclosed. The method includes communicating with a central database server system from at least one traveler client system, the central database server system in communication with a mainframe gateway server system, the mainframe gateway server system in communication with a mainframe system, providing traveler charge card transaction data to the mainframe system in communication with a corporate charge card provider, and providing general ledger processing, reimbursement processing, and payment processing by the central database server system and providing payment direction from the corporate banking provider to the corporate charge card provider by the central database server system.

### BRIEF DESCRIPTION OF THE DRAWINGS

For a better understanding of the present invention, reference may be made to the accompanying drawings in which:

FIG. 1 illustrates a diagrammatic representation of the global travel reporting system in accordance with the present invention, illustrating the major components and primary electronic transactions that flow in the use of the system;

FIG. 2 illustrates an exemplary traveler's interface screen for the global travel reporting system;

FIG. 3 illustrates an exemplary new expense book wizard interface screen for the global travel reporting system;

FIG. 4 illustrates an exemplary business purpose information interface screen for the global travel reporting system;

FIG. 5 illustrates an exemplary downloaded credit card charges interface screen for the global travel reporting system;

FIG. 6 illustrates an exemplary confirm interface screen for the global travel reporting system;

FIG. 7 illustrates an exemplary downloaded credit card charges informational interface screen for the global travel reporting system;

FIG. 8 illustrates an exemplary global travel reporting data entry interface screen for the global travel reporting system;

FIG. 9 illustrates an exemplary category selection interface screen for the global travel reporting system;

FIG. 10 illustrates an exemplary airline interface screen for the global travel reporting system;

FIG. 11 illustrates the exemplary data entry interface screen as shown in FIG. 8 for an airline expense in the global travel reporting system;

FIG. 12 illustrates the exemplary data entry interface screen as shown in FIG. 8 for a hotel credit card charge expense in the global travel reporting system;

FIG. 13 illustrates an exemplary hotel interface screen for the global travel reporting system;

FIG. 14 illustrates an exemplary credit card balance interface screen for the global travel reporting system;

FIG. 15 illustrates an exemplary dinner interface screen for the global travel reporting system;

FIG. 16 illustrates an exemplary resulting balance interface screen for the global travel reporting system;

FIG. 17 illustrates the exemplary data entry screen interface screen as shown in FIG. 8 for a in-room movie credit card charge in the global travel reporting system;

FIG. 18 illustrates the exemplary category selection interface screen of FIG. 9 for an in-house movie credit card charge for the global travel reporting system;

FIG. 19 illustrates an exemplary personal credit card charge interface screen for the global travel reporting system;

FIG. 20 illustrates the exemplary data entry screen interface screen as shown in FIG. 18 for indicating the in-room movie credit card charge as an expense in the global travel reporting system;

FIG. 21 illustrates the exemplary data entry screen interface screen as shown in FIG. 20 for indicating how to make manual entries in the global travel reporting system;

FIG. 22 illustrates the exemplary category selection interface screen of FIG. 9 for an entertainment charge for the global travel reporting system;

FIG. 23 illustrates the exemplary data entry screen interface screen as shown in FIG. 8 for indicating the submission of an expense book in the global travel reporting system;

FIG. 24 illustrates the exemplary data entry screen interface screen as shown in FIG. 22 for indicating confirmation of the submission of an expense book in the global travel reporting system;

FIG. 25 illustrates an exemplary expense book submission interface screen for the global travel reporting system; and

FIG. 26 illustrates an exemplary expense book successful indication of submission interface screen for the global travel reporting system.

### BEST MODE FOR CARRYING OUT THE INVENTION

In the following detailed description numerous specific details are set forth in order to provide a thorough understanding of the invention. However, it will be understood by those skilled in the art that the present invention may be practiced without these specific details. For example, the invention is not limited in scope to the particular type of software language or to particular conventions regarding software/hardware or network designations. In other instances, well-known methods, procedures, and components have not been described in detail so as not to obscure the present invention.

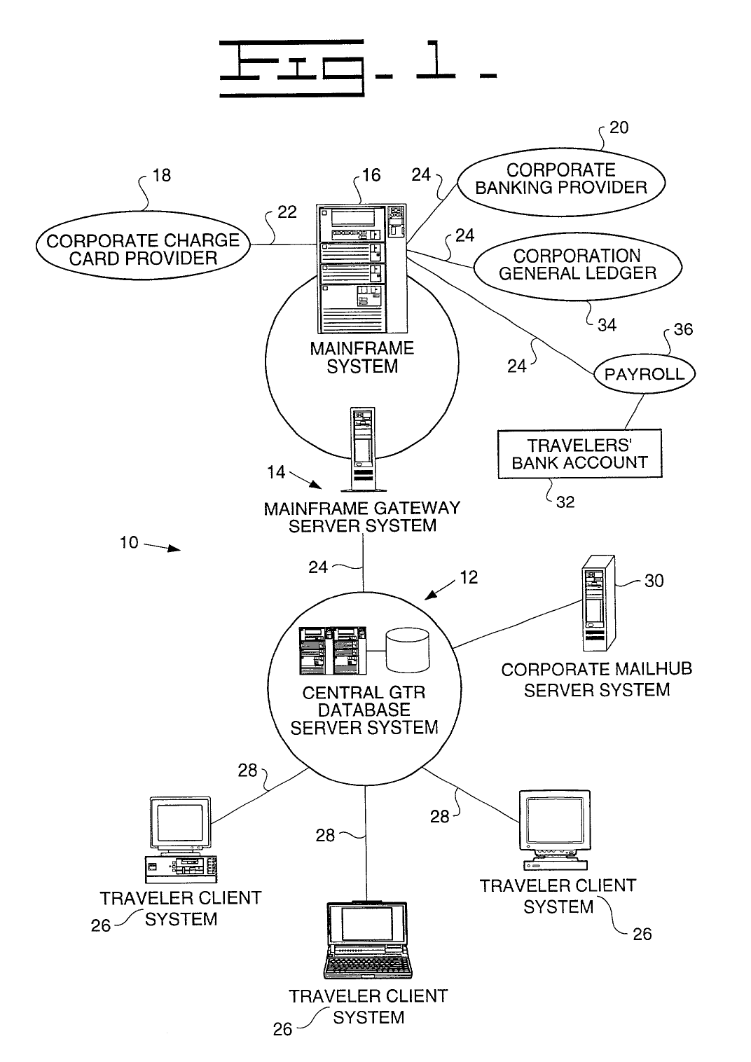

An embodiment of the global travel reporting system (“GTR”) of the present invention is shown in a simplified diagram in FIG. 1. The traveler client system 26 of the present invention may exist on any conventional personal computer or workstation running a suitable operating system such as Windows®, Windows NT®, or Linux® for example. The traveler client system 26 includes a bus, a processor coupled with the bus for processing information, and a main memory, such as RAM or other dynamic storage device, coupled to the bus for storing information and instructions to be executed by the processor. The traveler client system 26 further includes ROM or other static storage device coupled to the bus for storing static information and instructions for the processor. A storage device, such as a magnetic disk or optical disk is also provided and coupled to the bus for storing information and instructions. The traveler client system 26 also includes a visual display unit and a communication interface coupled to the bus. The communication interface provides a two-way data communication coupling to a network link that is connected to a local network. For example, communication interface may be a local area network (“LAN”) card to provide a data communication connection to a compatible LAN or a modem to provide a data communication connection to a corresponding type of telephone line. Wireless links may also be implemented. The network link 28 then provides data communication through one or more networks to other data devices, such as through a local network to a host computer or other server-client systems for example. It is understood that other details regarding the traveler client system 26, communication interface, and network architecture have been omitted so as to not obscure the present invention.

Accordingly, referring back to FIG. 1, the global travel reporting system, generally indicated by numeral 10, has the ability to be in communication with a central global travel reporting database server system 12, which is in communication with a mainframe gateway server system 14, which is in communication with a mainframe system 16, all via network connections 24. The mainframe system 16 is also in communication with a corporate charge card provider 18 via a dedicated connection 22 as well as a corporate banking provider 20 via the network connection 24. A dedicated connection 22 is a network-type connection for use by a designated user and is not shared in common among multiple users as are dial-up lines.

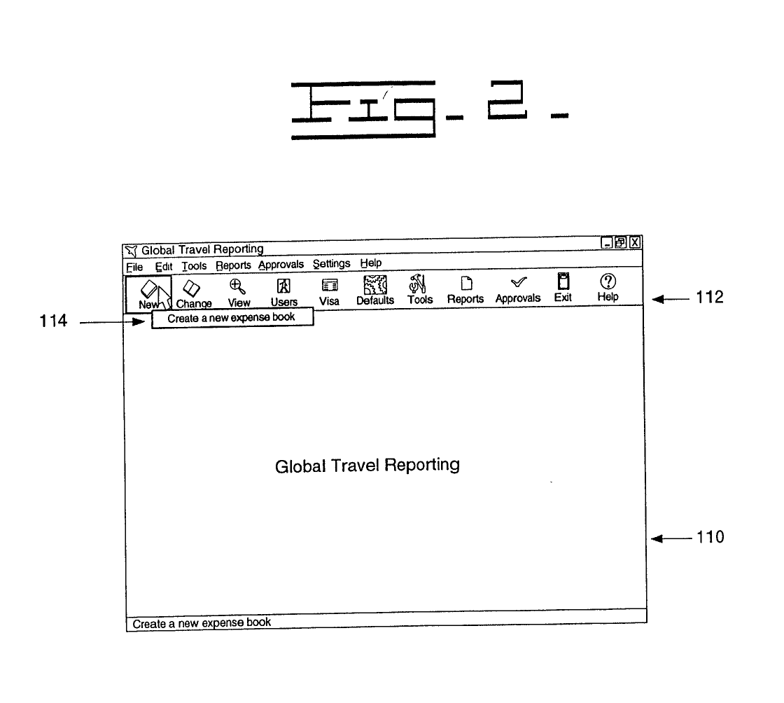

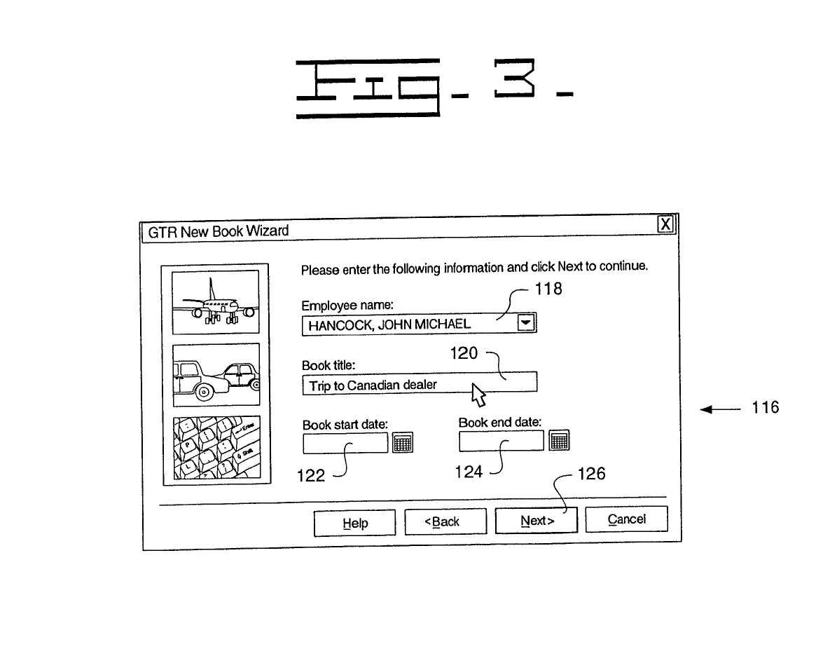

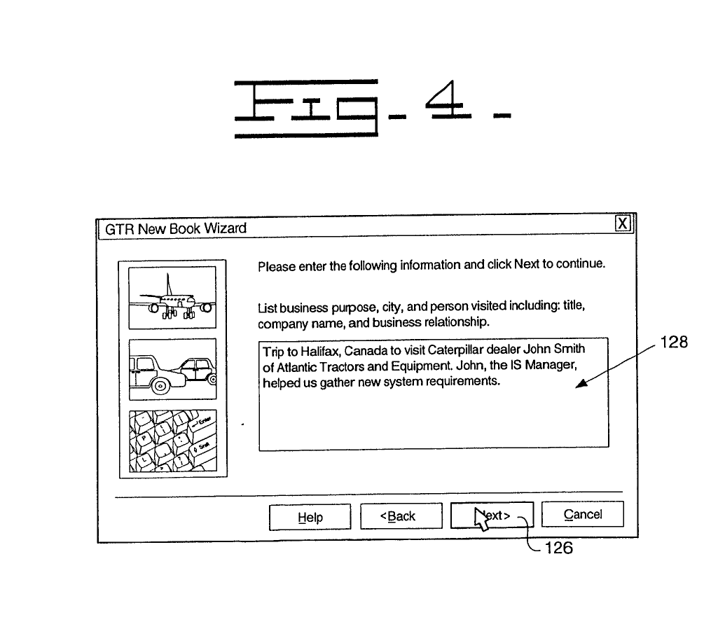

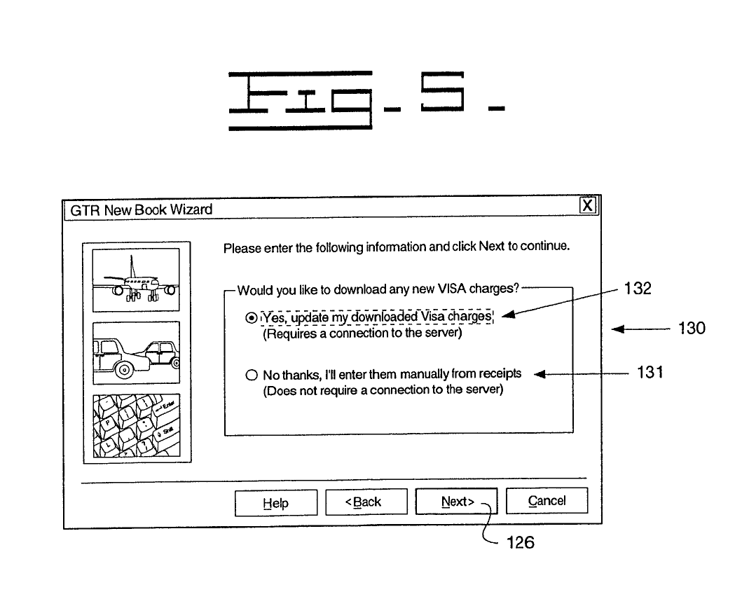

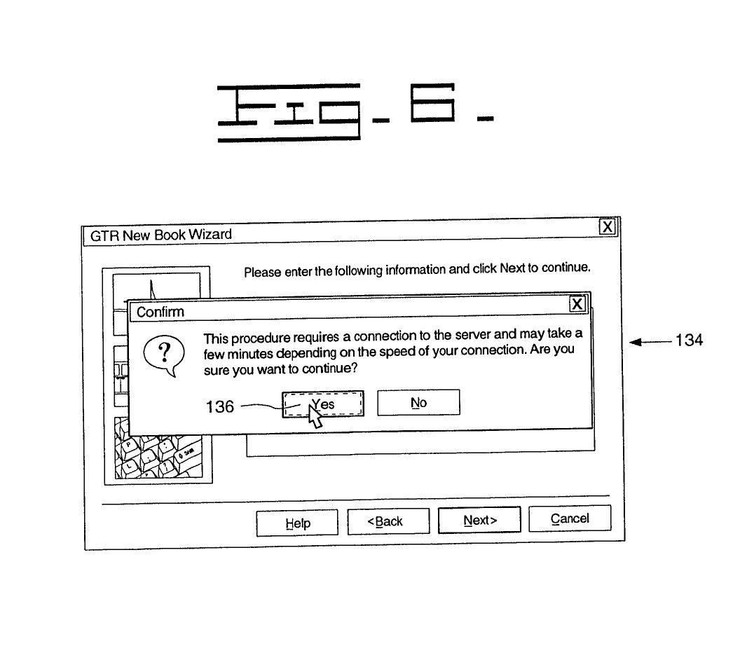

In order to fully appreciate the operation of the present invention, it is helpful to consider an example wherein an expense book is completed. Suppose that a traveler wishes to create a new expense book. When the traveler opens the global travel reporting program, a traveler interface screen 110 is displayed as shown in FIG. 2. The icons at the top of the screen 112 allow a traveler to do most of the basic tasks in the global travel reporting system 10. A new expense book is created by clicking on the “New” icon 114. After clicking on the “New” icon 114, a global travel reporting new expense book wizard interface screen, generally indicated by numeral 116, opens and asks for basic trip information, as shown in FIG. 3. For explanatory purposes, this embodiment will report expenses from a recent trip to Canada from the United States. This includes employee name 118, expense book title 120, expense book start date 122, and expense book stop date 124. After the traveler enters the requested information and clicks on the “Next” button 126, the interface screen in FIG. 4 is shown. Here, information related to business purpose, city, and person visited is entered and is generally indicated by numeral 128. After entering the requested information and clicking on the “Next” button 126, the download credit card charges interface screen shown in FIG. 5 appears, which is generally indicated by numeral 130. Here, the traveler is asked whether he or she would like to download any new credit card charges or enter any credit card charges manually. In the preferred embodiment, and this example, the traveler will choose to have any credit card charges downloaded from the central global travel reporting database server system 12. Using the downloaded credit card charges 132 will save the traveler time and reduce errors because, for example, less data is being entered manually 131, accurate exchange rates are readily available, proper payment of airline tickets is assured, and reconciliation of the travelers' corporate charge card statement is facilitated, as will be explained in more detailed below. After selecting to have any new credit card charges downloaded and after entering the requested information and clicking on the “Next” button 126, a confirm interface screen 134 appears, as show in FIG. 6, and notifies the traveler that this procedure requires connection to the central global travel reporter database server system as well as confirms the desired downloading of the credit card charges.

When the traveler clicks the “Yes” button 136 in FIG. 6, the traveler client system 26 begins communication with the central global travel reporter database server system 12 through a network link 28, as explained previously. The central global travel reporter database server system 12 then accesses the traveler charge card transaction data, which is received from the mainframe system 16 through the mainframe gateway server system 14, and uploads the respective data to the traveler client system 26.

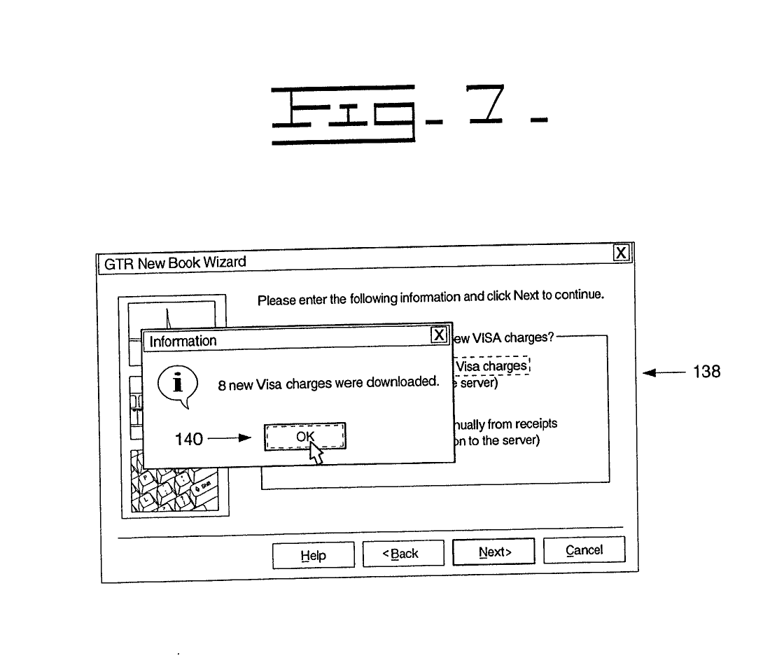

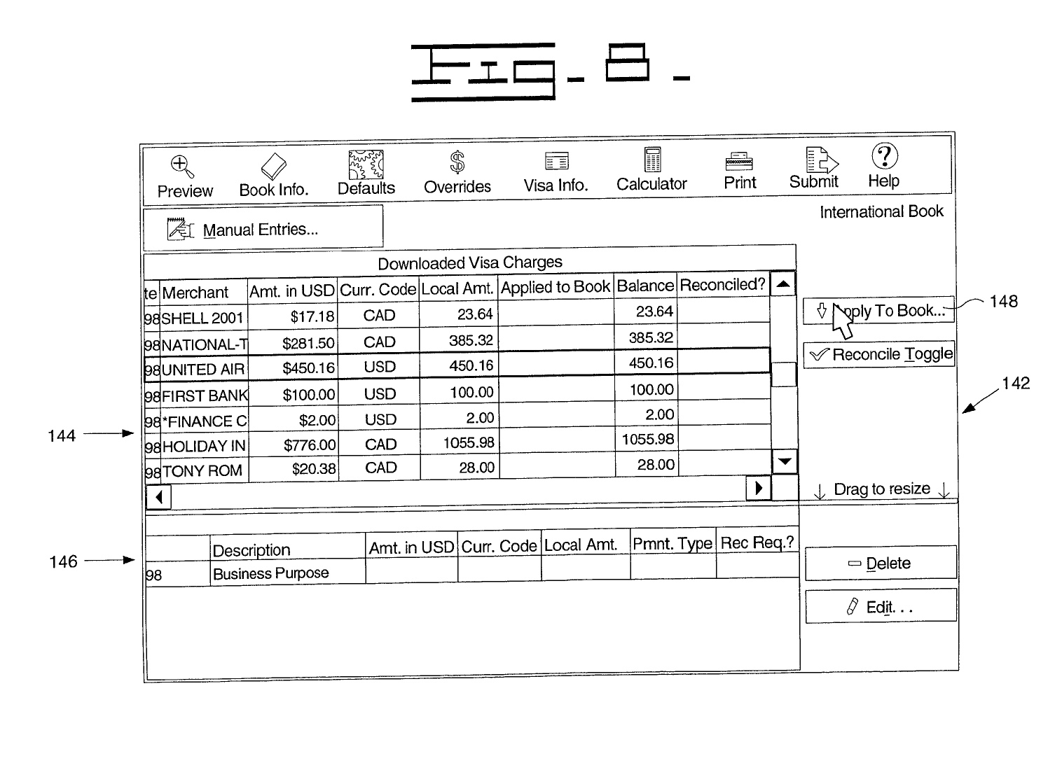

After the credit card charges are successfully downloaded from the central global travel reporter database server system 12, the downloaded credit card charges information interface screen 138 appears, as shown in FIG. 7, and notifies the traveler of the number of charges downloaded. Once the traveler clicks the “OK” button 140, the global travel reporting data entry interface screen 142 appears, as shown in FIG. 8. The top grid 144 shows the downloaded credit card charges. The bottom grid 146 shows the current traveler expense book and is filled in as charges are applied and as manual cash entries are entered.

Referring again to FIG. 8, and starting with the downloaded credit card charge for the traveler's airline ticket, the traveler highlights the credit card charge and then clicks the “Apply” button 148. By applying the credit card charge for the airline ticket to the expense book entry area, a prior-to-travel separate traveler expense book is eliminated because the global travel reporting system 10 strips the airline credit card charge from the corporate charge card statement by pre-paying the corporate charge card provider 18 on the traveler's behalf. More particularly, because many airline tickets are purchased significantly prior to the start of a traveler's trip (when most expense books are completed), this pre-payment process insures avoidance of late charges from the corporate charge card provider in addition to eliminating the necessity for the traveler to create an additional expense book prior to his trip.

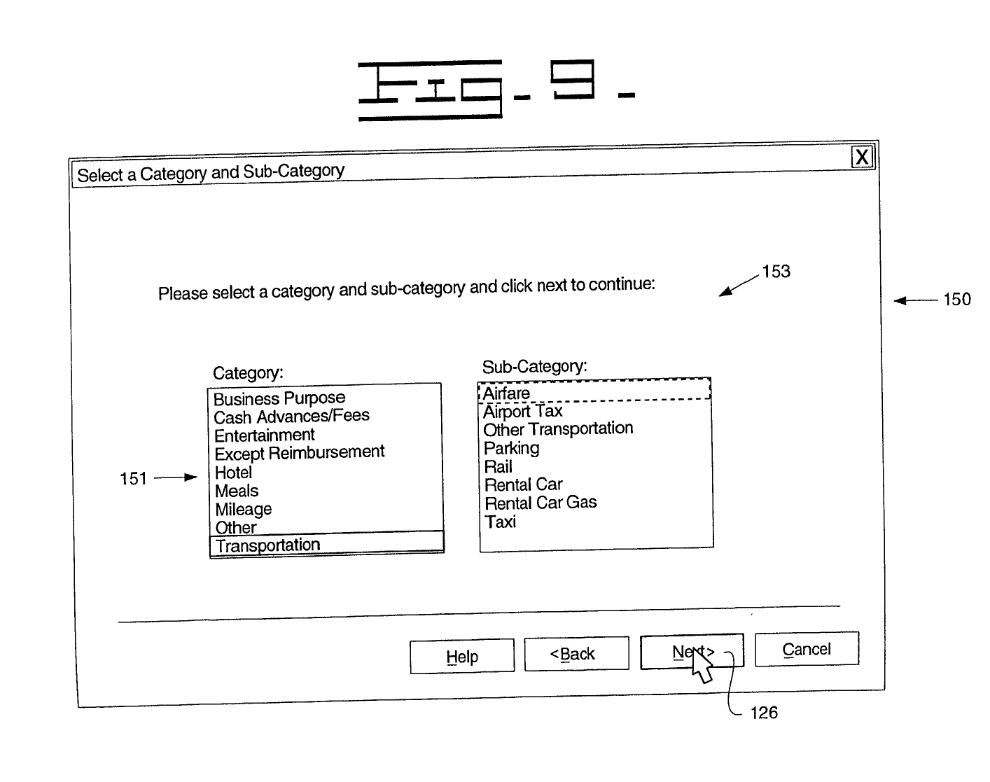

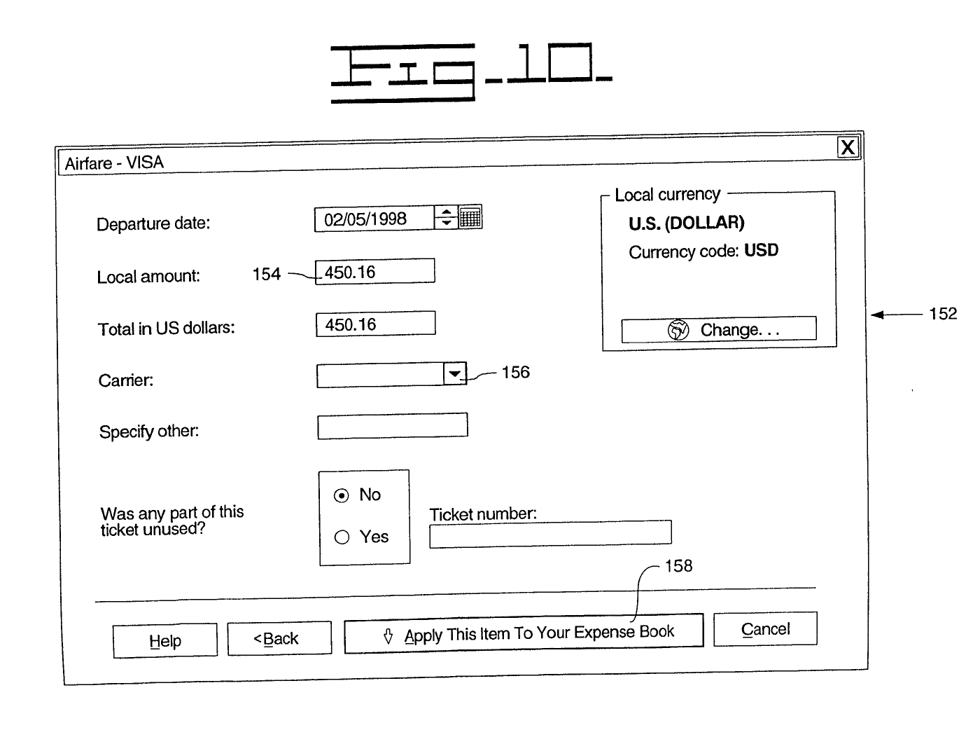

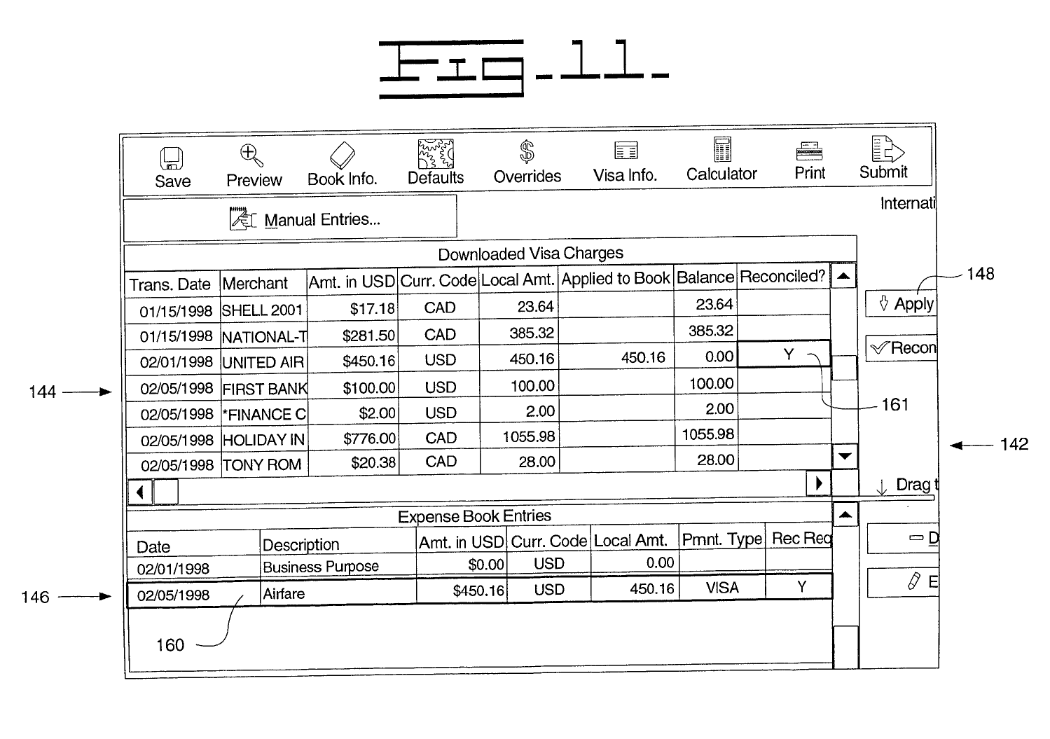

As illustrated through the category selection interface screen 150 in FIG. 9, the traveler then selects a category 151 and sub-category 153 for the expense just applied. After clicking the “Next” button 126, the airfare interface screen 152 appears, as shown in FIG. 10. The airfare amount 154 is carried into this interface screen and identification of the carrier vendor 156 is requested. Identification of vendors in the global travel reporting system 10 is requested because this information can significantly aid a corporation in the collection of information to more effectively negotiate supplier discounts. Applying this item to the traveler's expense books is done by clicking on the corresponding button 158. The traveler is then taken back to the global travel reporting data entry interface screen 142 where the airfare charge 160 has now been applied to the expense book in the bottom grid 146, as illustrated in FIG. 11. Notice also that there is a “Y” 161 in the reconciled column in the top grid which contains the downloaded charges. Allowing the traveler to reconcile his downloaded corporate credit card charges while creating an expense book saves the traveler additional time in reporting travel expenses. In prior systems, the traveler had to compare each monthly credit card charge card statement to his expense book by hand to make sure he had accounted for each credit card charge transaction. Any credit card transactions that are not reconciled continue to show up in the downloaded charges area in the top grid 144 thereby forcing the traveler to account for each and every credit card transaction. Similar to the other unique features of this global travel reporting system 10, the reconciliation feature 161 ultimately aids the traveler in being more productive to the corporation through reduced time being spent on travel reporting. The remaining downloaded charges can be applied in a similar manner.

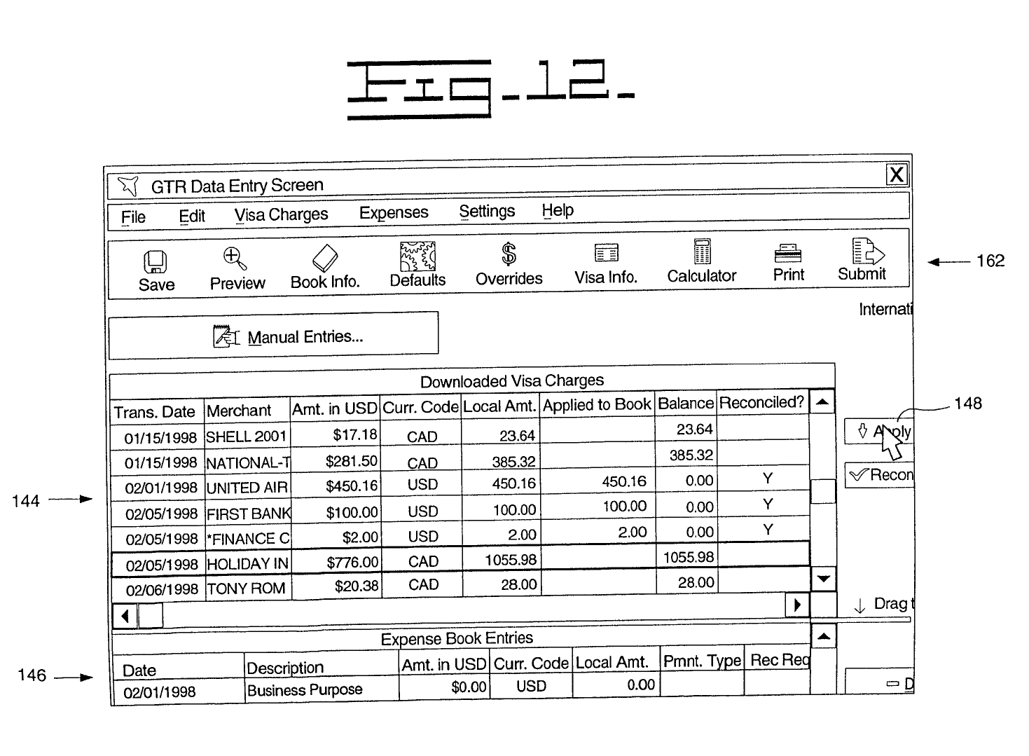

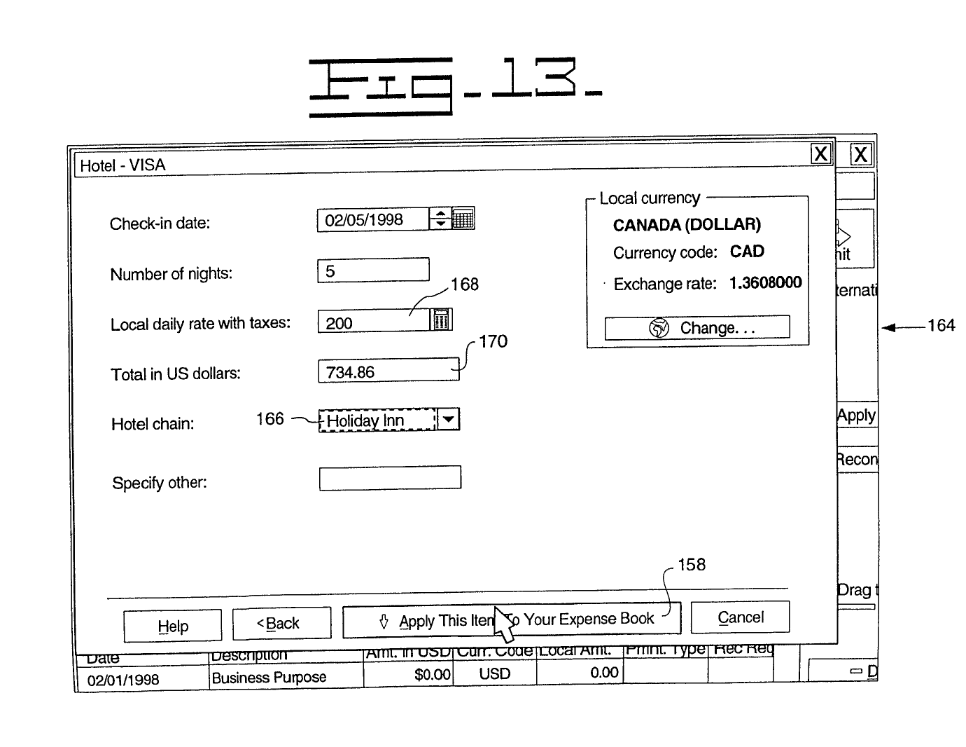

In another embodiment of the invention, as shown in FIG. 12, the traveler desires to apply a downloaded hotel credit card charge through the downloaded credit card charge interface screen that is generally indicated by numeral 162. Many credit card charges contain several items billed on one charge. In this example, the hotel bill charge included charges for the room, dinner, and an in-room movie. As previously discussed, the traveler applies the hotel credit card charge to his expense book through the “apply” button 148 and selects the category and sub-category of the expense in another interface screen similar to that shown in FIG. 9. After making his selections, the hotel interface screen 164 appears, as shown in FIG. 13, and the traveler is again requested to enter the hotel vendor 166, just as done with the airline carrier vendor identification 156 in FIG. 10. It is pointed out in this embodiment that because the credit card charge 168 was made in something other than United States dollars, the currency code and currency rate used by the corporate charge card provider 18 is automatically applied to the hotel charge and reflected in the “Total in US dollars” space 170. This eliminates any currency rate differences between the traveler's charge card bill and the traveler's expense book as well as provides immediate and accurate currency rates which in turn eliminates guessing about exchange rates and allows for quick and efficient creation of a more precise expense book.

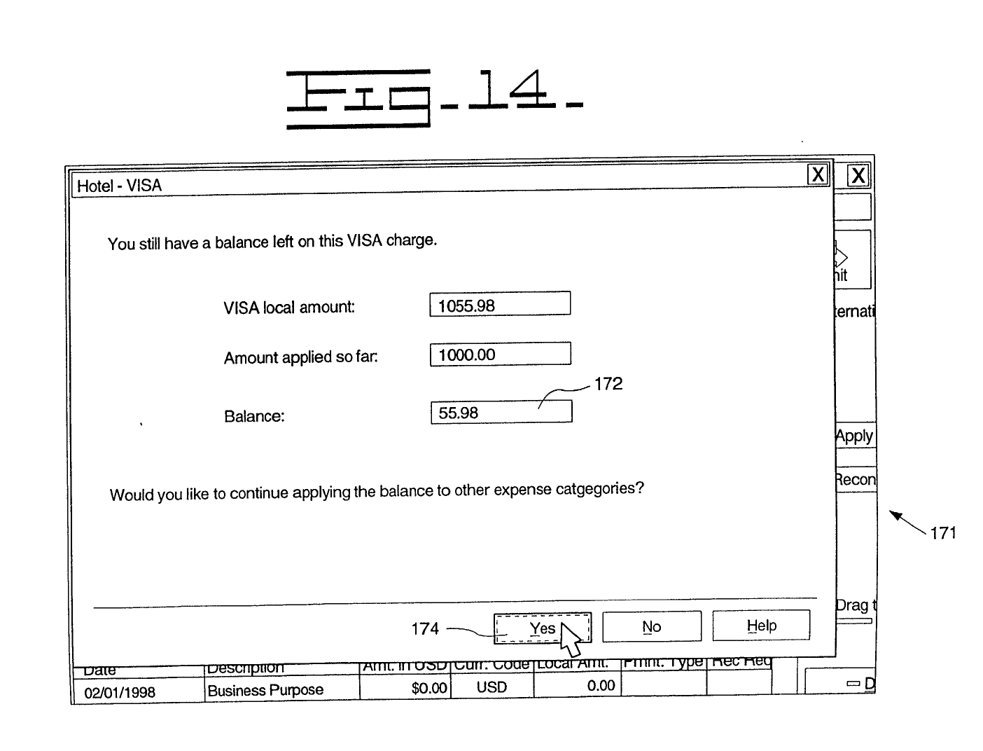

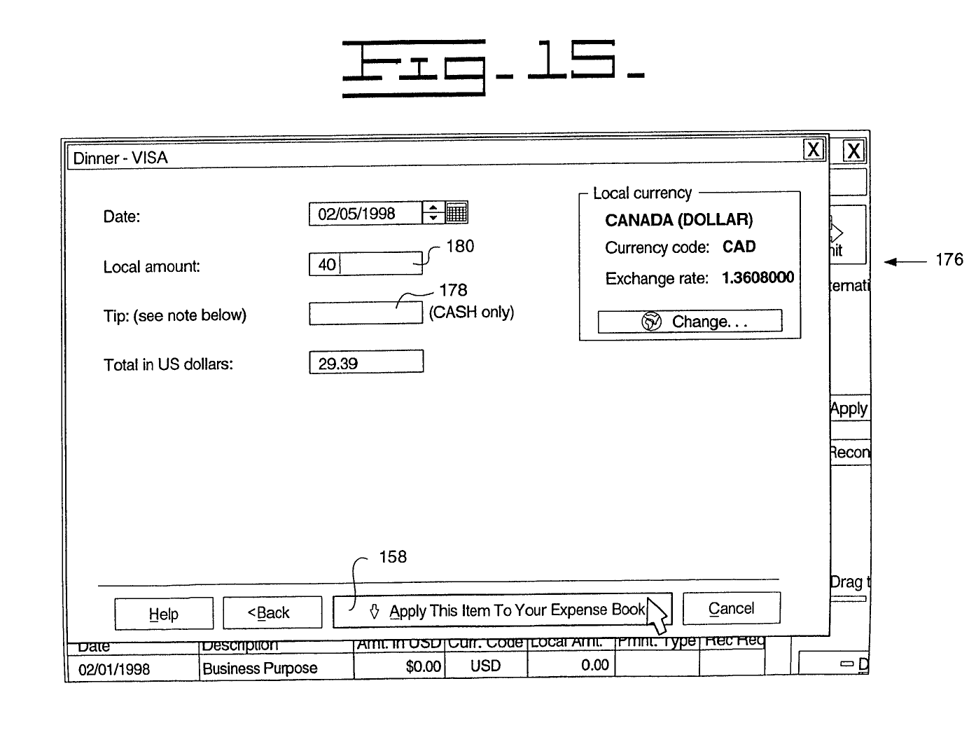

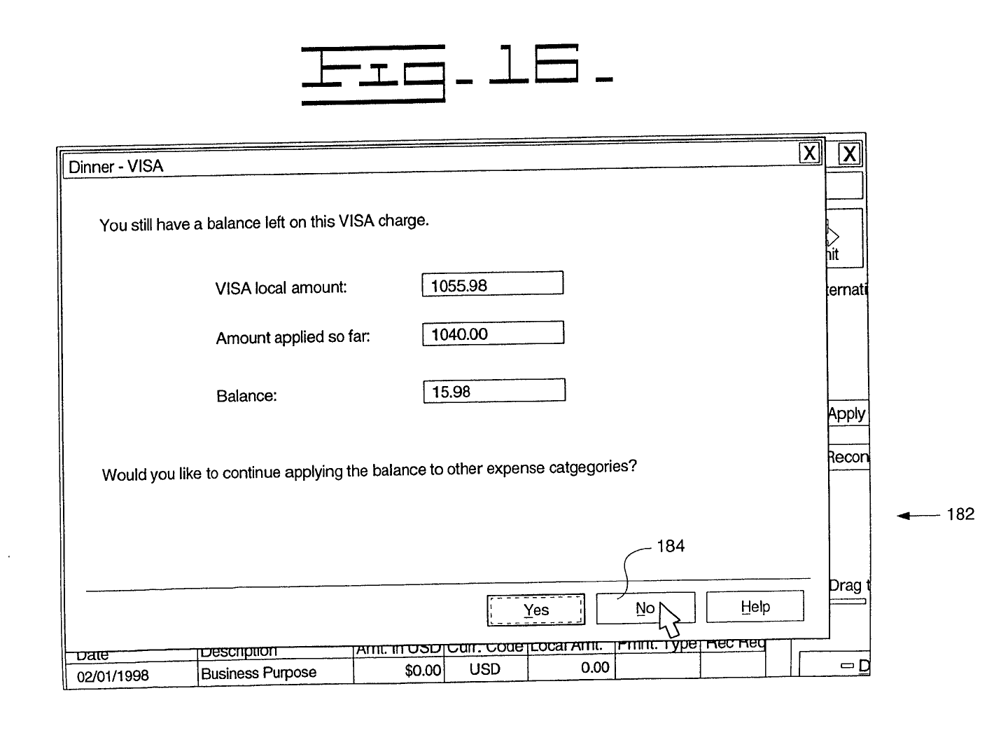

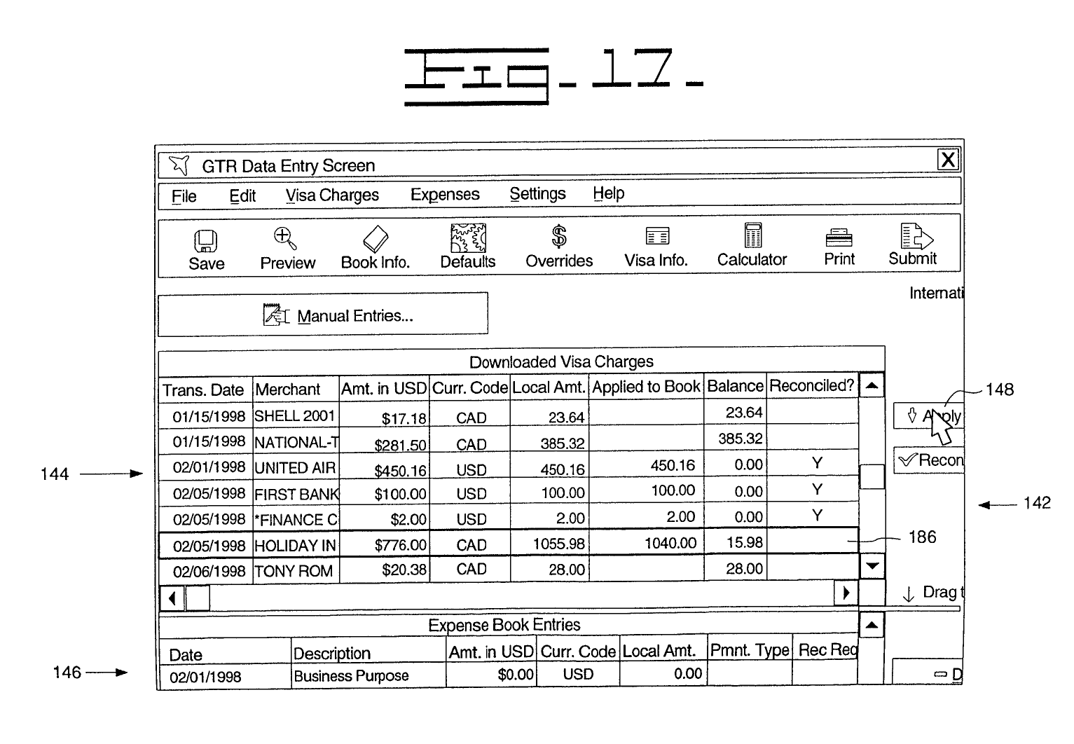

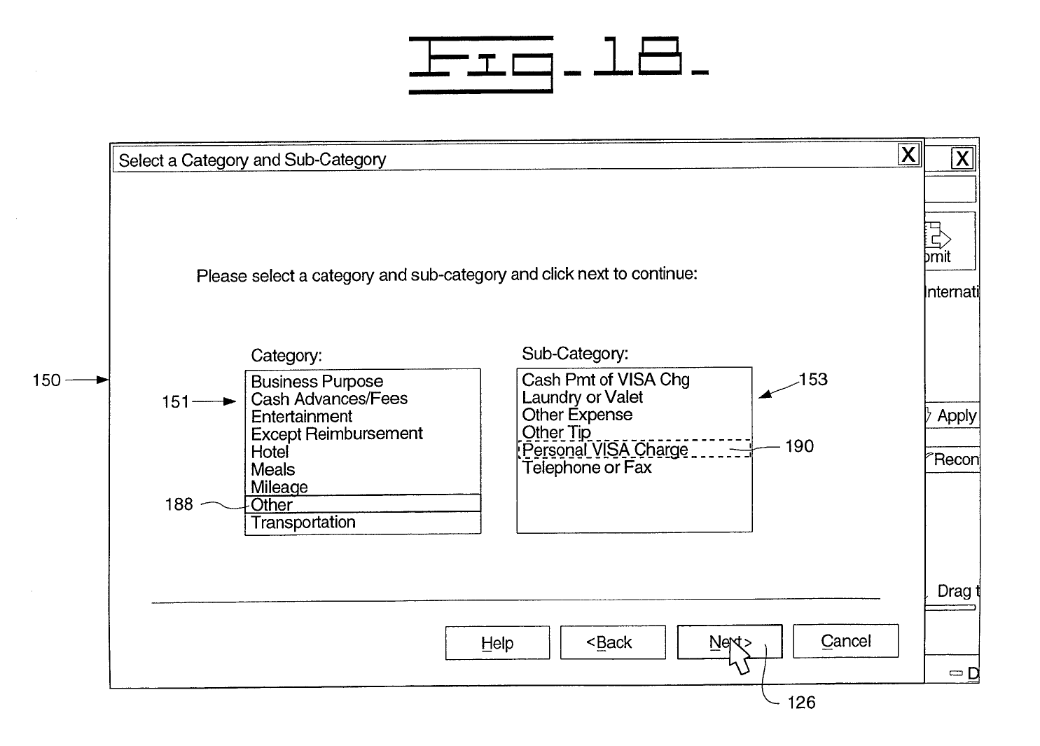

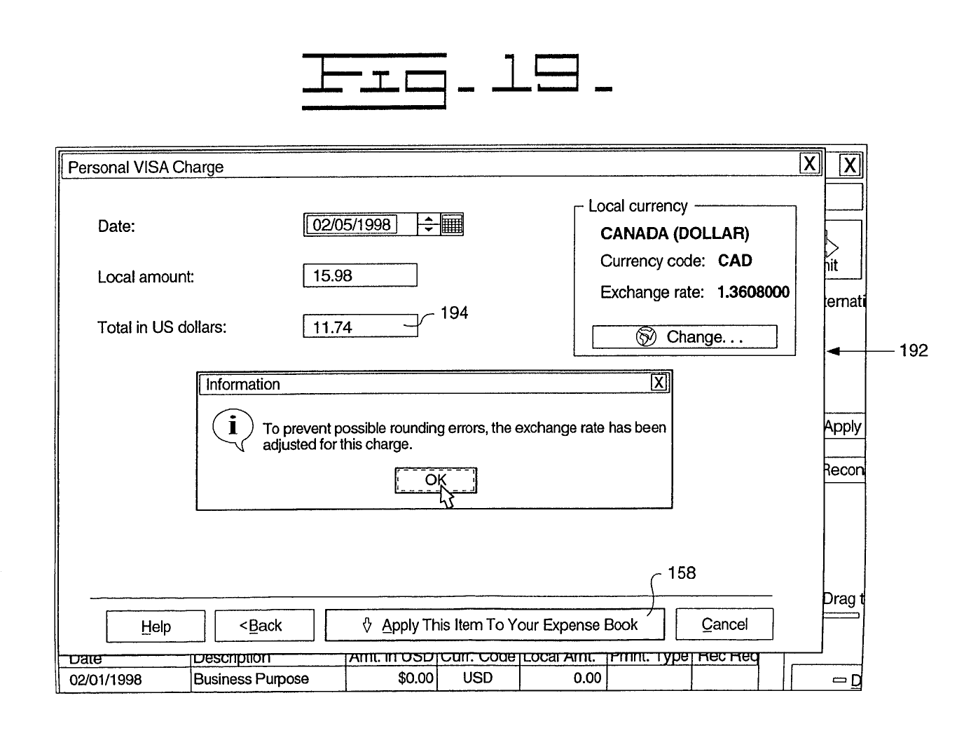

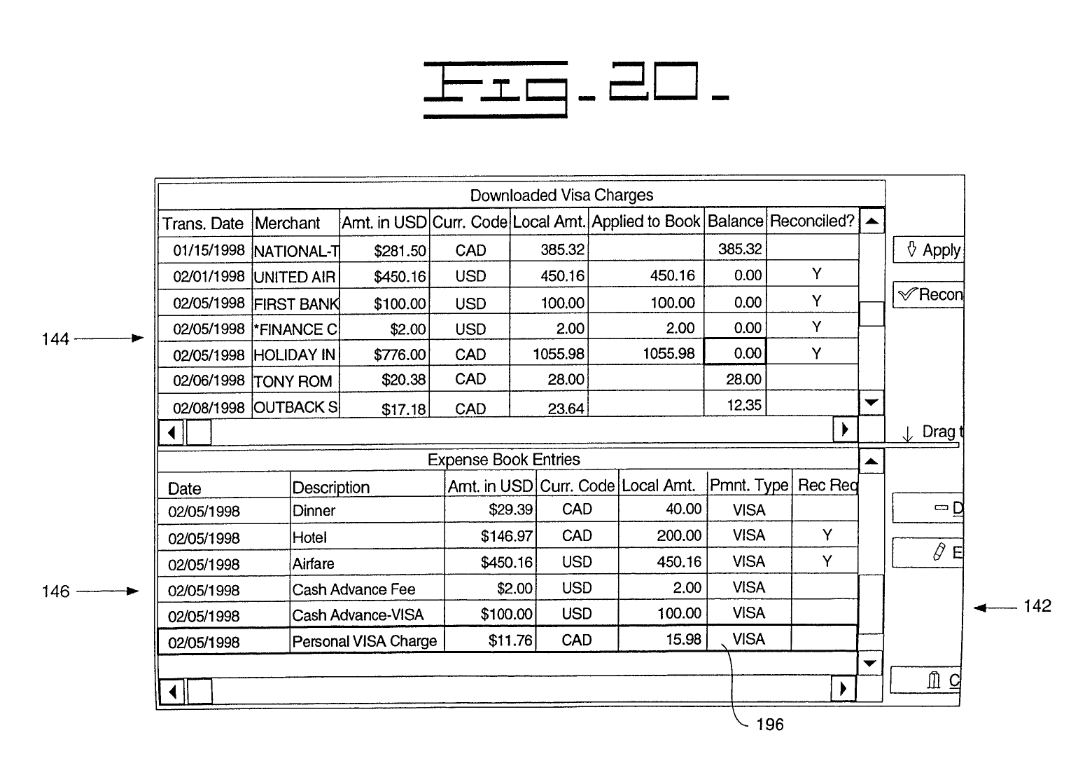

When the traveler then applies this credit card charge to his expense book, by clicking on the respective “apply this item to the expense book” button 158, he or she is notified, as shown in FIG. 14, that a balance 172 is still left on the charge through the credit card balance interface screen 171. The traveler is now allowed to apply the balance to other expense categories. Because the traveler also applied dinner to the room he will click the “Yes” button 174 where selection of a category and sub-category will take place, as previously explained. The dinner interface screen 176 will then appear, as illustrated in FIG. 15, where the traveler verifies the dinner cost 180 and tip expense 178. Here, the global travel reporting system 10 lets the traveler refrain from separating the tip expense from the meal expense if the tip was included in the credit card charge. A tip expense 178 is only entered, then, if the tip expense was paid in cash. The global travel reporting system 10, thus, in this embodiment saves the traveler additional time by eliminating steps to complete an expense book if the tip was included in the credit card charge. When the traveler then applies this credit card charge to his expense book, by clicking on the respective button “apply this item to the expense book” 158, he or she is notified again through a resulting balance interface screen 182 as shown in FIG. 16, that a balance is still left on the credit card charge relating to the in-room movie. Because the cost of the in-room movie should not be applied to the traveler's expense book, he or she will click the “No” button 184 and subsequently return to the global travel reporting system data entry interface screen 142, as illustrated in FIG. 17. Now, there is a balance of $15.98 for the in-room movie credit card charge 186. The traveler has the option of handling this in one of two ways. Namely, the traveler may send a personal check to the corporate charge card provider 18 or highlight this amount and apply the amount to this expense book as a personal charge. In this example, the traveler chooses to apply the charge to his expense book. Accordingly, after highlighting the credit card in-room movie charge 186 and clicking on the “Apply” button 148, the category selection interface screen 150 appears, as shown in FIG. 18 where the traveler then selects a category 151 and sub-category 153 for the expense just applied. Here, the traveler selects Category “Other” 188 and Sub-Category “Personal VISA® Charge” 190. By making it a personal charge, the global travel reporting system 10 will pay the corporate charge card provider 18 for the traveler and reduce the amount of cash the traveler is reimbursed due to out-of-pocket expenses thereby saving time and money. After clicking “Next” 126 the personal VISA® credit card charge interface screen 192 appears, as shown in FIG. 19, where the currency code and current rate used by the corporate charge card provider is automatically applied to the personal charge and reflected in the “Total in US dollars” space 194. Once the traveler clicks the button to “apply this item to the expense book” 158, the global travel reporting data entry interface screen 142 appears again with the in-room movie credit card charge 186 applied to the expense book in the bottom grid 146 as indicated by numeral 196, as illustrated in FIG. 20.

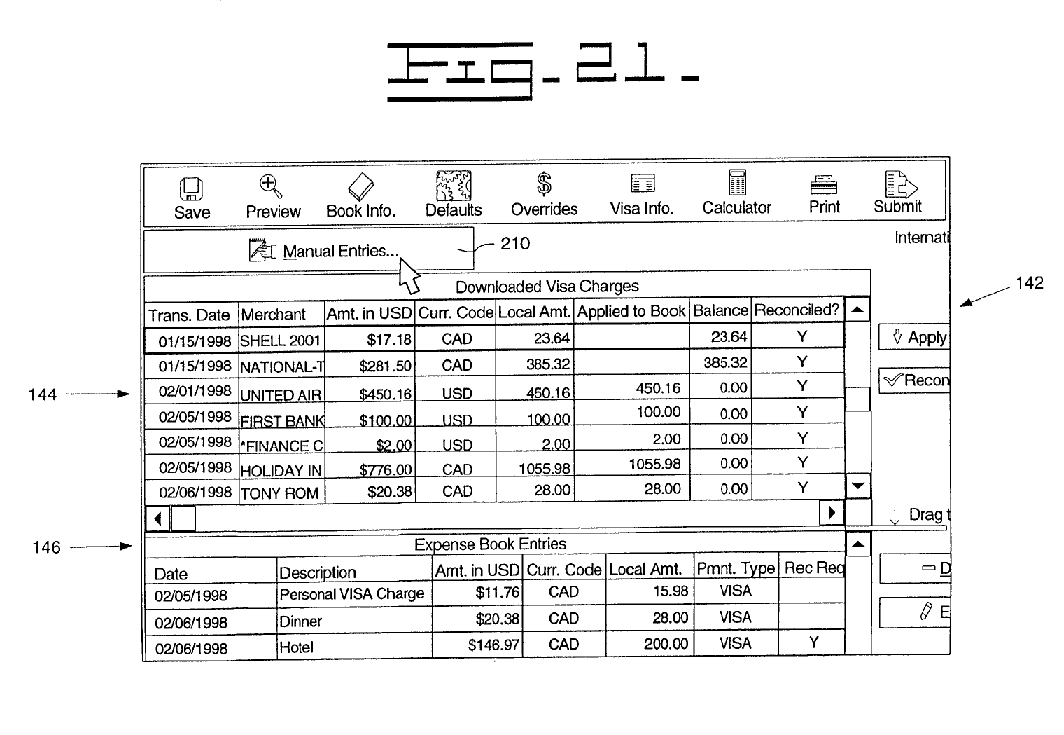

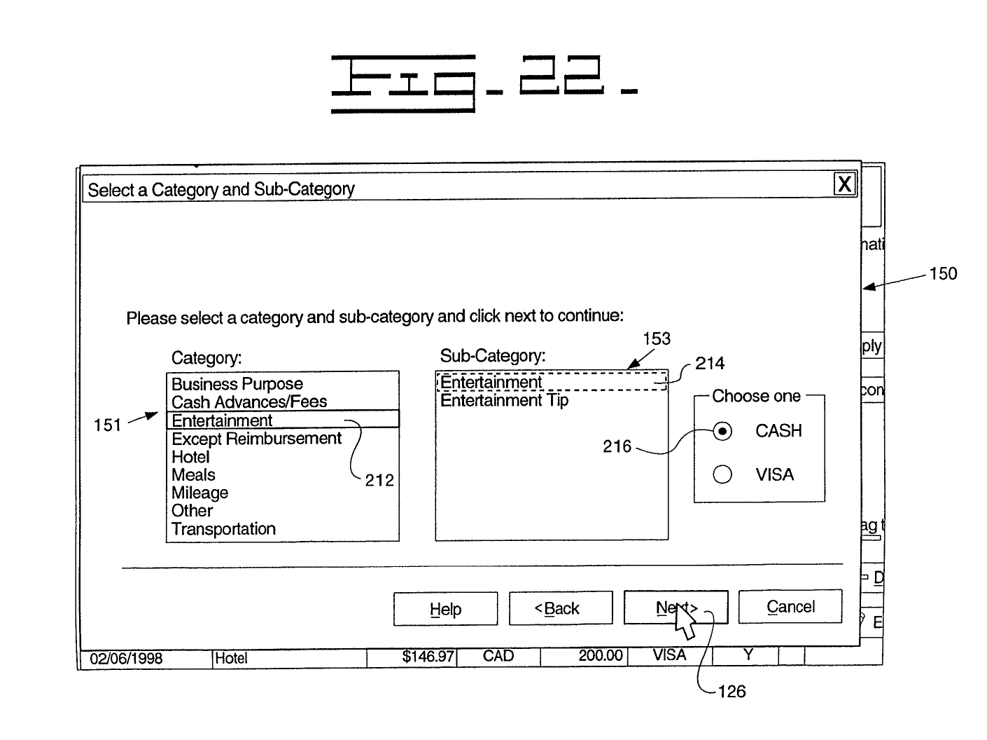

While in the global travel reporting data entry screen 142, as shown in FIG. 21, cash expenses can also be entered by using the “Manual Entries” button 210. Once clicked, the category selection interface screen 150 appears, as shown in FIG. 22 where the traveler then selects a category 151 and sub-category 153 for the expense just applied. Here, the traveler selects Category “Entertainment” 212 and Sub-Category “Entertainment” 214 and the “CASH” element 216 is clicked on. After clicking the “Next” button 126, similar interface screens are stepped through as stated above, and the cash expenditure is entered into the traveler's expense book.

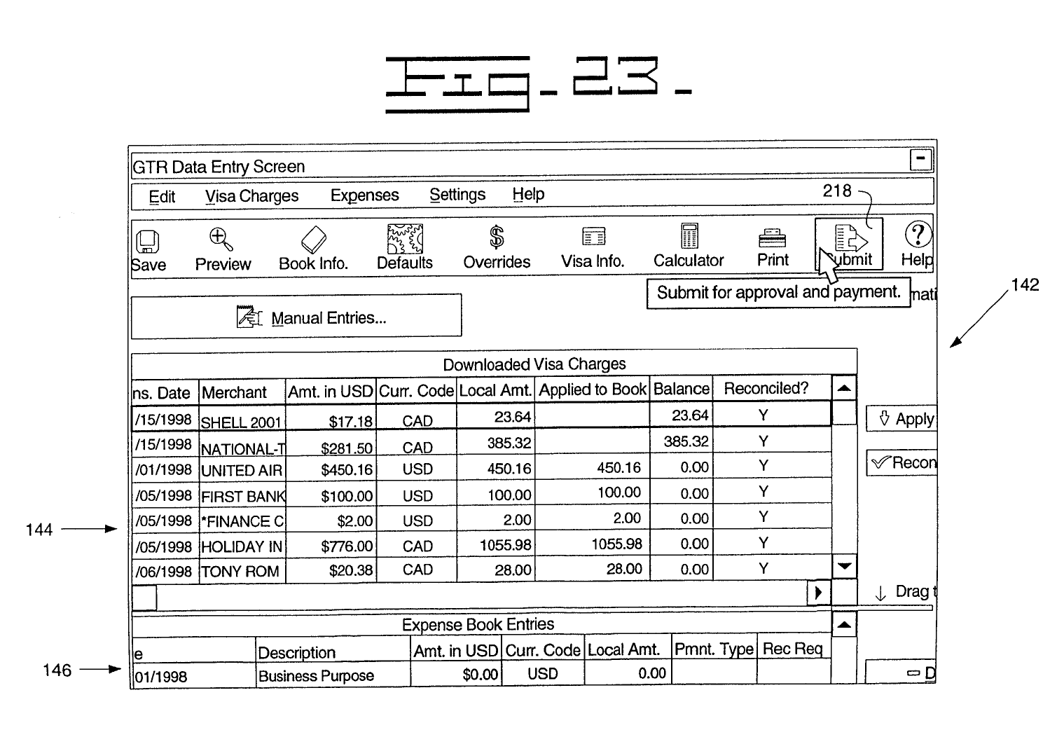

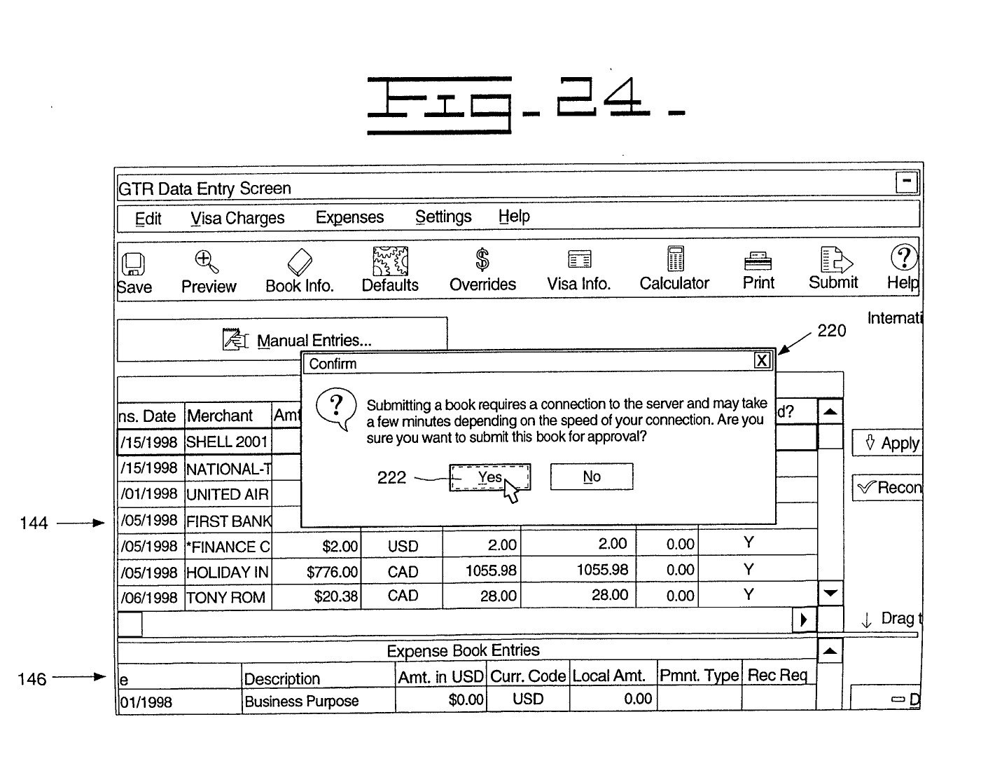

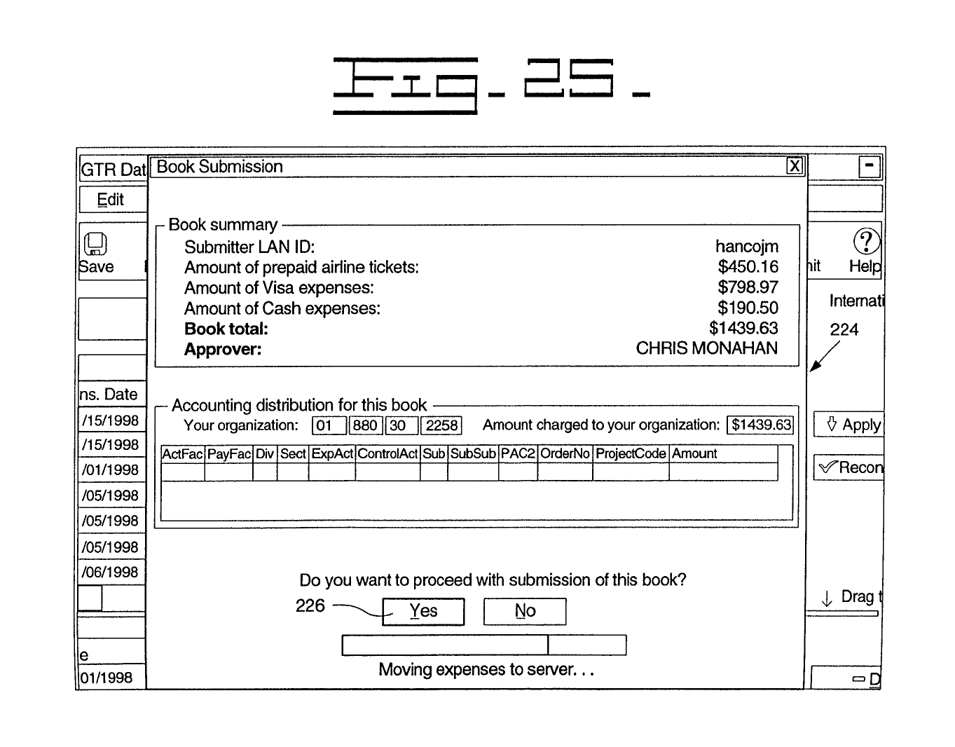

After entering all desired expenditures into an expense book a traveler will now submit the book for approval and payment. An expense book usually must be approved by supervisor either before or after payment for reasons of accuracy in accounting and budgeting, for example. Accordingly, the “Submit” icon 218 in the global travel reporting data entry interface screen 142 is depressed by the traveler, as shown in FIG. 23, and a “confirm” interface screen 220 appears, as shown in FIG. 24. This “confirm” interface screen 220 notifies the traveler that submitting an expense book requires a connection to the central global travel reporting database server system 12 and requests confirmation. Once the traveler clicks “Yes” 222, an expense book submission interface screen 224 appears, as shown in FIG. 25, which illustrates a summary of the expense book for the traveler. If the traveler wishes to proceed with the submission, the “Yes” button 226 is clicked and the expense book is uploaded from the traveler client system 26 to the mainframe system 16 via the central global travel reporting database server system 12 and the mainframe gateway server system 14 via a network connection 24 as previously explained. However, due to automatic editing in the global travel reporting system 10, the expense book is not actually submitted to the central global travel reporting database server system 12 if the data entered by the traveler is not valid or has defects. Automatically editing an expense book prior to actual submission assures that a valid expense book is submitted to the global travel reporting system 10 in addition to preventing defects from occurring when the data posts to the corporate general ledger system 34. This feature saves valuable time by providing early error resolution for the traveler.

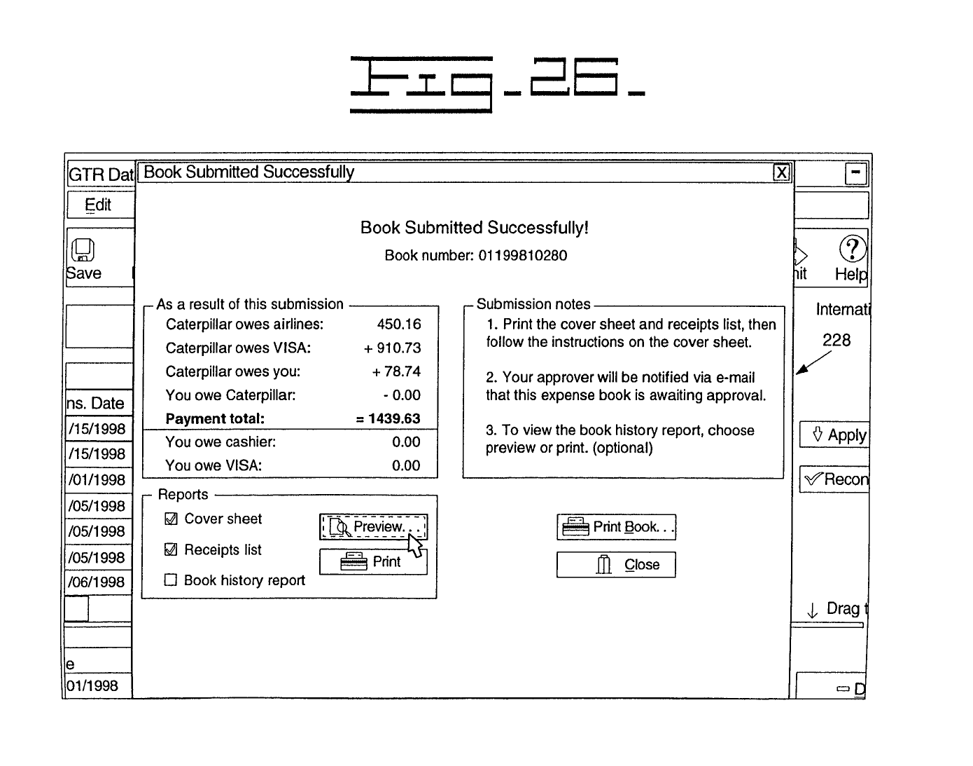

If the expense book is submitted successfully, the central global travel reporting database server system 12 then sends an email to the traveler's approver, using the approver's email address received from the corporate email directory in the corporate mailhub sever system 30, to notify the approver that the expense book is awaiting their approval. After successful submission of the expense book to the central global travel reporting database server system 12, the “Book Submitted Successfully” interface screen 228 appears, as illustrated in FIG. 26, showing the results of the submission, the next steps to be taken, as well as various report printing options.

### INDUSTRIAL APPLICABILITY

In this embodiment of the global travel reporting system 10, notice the amounts that will be automatically paid on the traveler's behalf thereby requiring no other action by the traveler for these payments to take place. Also, notice that printing of the expense book is not necessary because the traveler's supervisor may approve the expense book on-line.

The approver gains access to the global travel reporting system 10 in a similar manner as the traveler, via the central global travel reporter database server system 12. After electronically approving the expense book, the central global travel reporter database server system 12 directs the mainframe system 16, via the mainframe gateway server system 14, to transfer funds from the corporate banking provider 20 to the corporate charge card provider 18 as well as from reimbursement processing directly to the traveler's bank account 32 via payroll 36. The ability to transfer funds directly from the corporate banking provider 20 to the corporate charge card provider 18 allows for added savings in the form of rebates, for example, from the corporate charge card provider 18 due to quick payment of corporate charge card accounts. The central global travel reporting database server system 12 also transmits the various transactions created and approved to the corporate general ledger system 34 for accounting purposes.

Further, as a result of the global travel reporting method and system, the significant costs associated with an outside company processing expense books are completely eliminated and expense book processing is brought in-house which allows for reduced costs, flexibility to enhance processes, and tight integration with other corporate systems in addition to enhancing traveler productivity and simplifying reporting for travelers while providing comprehensive information to travelers, supervisors, managers, and the corporation in general.

While certain features of the invention have been illustrated as described herein, many modifications, changes and equivalents will now occur to those skilled in the art. It is, therefore, to be understood that the appended claims, are intended to cover all such modifications and changes as fall within the true spirit of the invention. It is also preferred that the present invention be limited not by the specific disclosure herein, but by the scope of the appended claims. Other aspects, objects and advantages of the present invention can be obtained from a study of the drawings, the disclosure and the appended claims.

1. A global travel reporting system, comprising:
at least one traveler client system in communication with a central database server system;
a mainframe gateway server system in communication with a mainframe system and said central database server system;
a corporate charge card provider in communication with said mainframe system to provide traveler charge card transaction data;
a corporate banking provider in communication with said mainframe system for receiving payment direction and said central database server system provides general ledger transaction processing, reimbursement processing, and payment processing and directs payment from said corporate bank provider to said corporate charge card provider.

2. The global travel reporting system of claim 1, wherein said traveler client system downloads said traveler charge card transaction data from said central database server system to create an expense book.

3. The global travel reporting system of claim 2, wherein said expense book is created without a hypothecation of foreign exchange rates.

4. The global travel reporting system of claim 2, wherein a connection to said mainframe system via said central database server system and said mainframe gateway server system by said traveler client system provides submission of said expense book with an automatic review and editing of information entered into said expense book.

5. The global travel reporting system of claim 2, wherein said traveler client system submits said expense book to said central database server system for processing.

6. The global travel reporting system of claim 1, wherein said central database server system provides said payment direction to payroll and reimburses travelers' bank account for said traveler's out-of-pocket expenses via said reimbursement processing and pays said corporate charge card provider for said traveler charge card transactions via said payment processing.

7. The global travel reporting system of claim 1, wherein said corporate charge card provider further provides valid cardholder information via said dedicated connection.

8. The global travel reporting system of claim 1, further comprising a corporate mailhub server system including at least one copy of a corporate email directory in communication with said central database server system.

9. The global travel reporting system of claim 8, wherein said corporate email directory is utilized by said central database server system to automatically send notifications regarding expense book incompleteness, approval, and rejection.

10. A method for global travel reporting, comprising:
communicating with a central database server system from at least one traveler client system, said central database server system in communication with a mainframe gateway server system, said mainframe gateway server system in communication with a mainframe system;
providing traveler charge card transaction data to said mainframe system in communication with a corporate charge card provider;
providing general ledger processing, reimbursement processing, and payment processing by said central database server system; and
providing payment direction from said corporate banking provider to said corporate charge card provider by said central database server system.

11. The global travel reporting method of claim 10, further comprising downloading said traveler charge card transaction data from said central database server system into said traveler client system to create an expense book.

12. The global travel reporting method of claim 11, further comprising creating said expense book without a hypothecation of foreign exchange rates.

13. The global travel reporting method of claim 11, further comprising reviewing and automatically editing information entered into said expense book through connection to said mainframe system via said central database server system and said mainframe gateway server system by said traveler client system for submission of said expense book.

14. The global travel reporting method of claim 11, further including submitting said expense book from said traveler client system to said central database server system for processing.

15. The global travel reporting method of claim 10, further including reimbursing a traveler's bank account for traveler out-of-pocket expenses via said reimbursement processing and paying said corporate charge card provider for traveler charge card transactions via said payment processing by providing said payment direction to said corporate banking provider.

16. The global travel reporting method of claim 10, further including providing valid cardholder information via said dedicated connection from said corporate charge card provider.

17. The global travel reporting method of claim 10, further including receiving from a corporate mailhub server system in communication with said central database server system at least one copy of a corporate email directory.

18. The global travel reporting method of claim 17, further including notifying a traveler automatically regarding expense book incompleteness, approval, and rejection via said central database server system using said corporate email directory.

19. Computer-readable media tangibly embodying a program of instructions executable by a computer to perform global travel reporting, the program of instructions embodied in computer-readable media performing the sequence, comprising:
downloading traveler charge card transaction data from a central database server system to create an expense book, said traveler charge card transaction data obtained by said central database server system directly from a corporate charge card provider and having currency data for application to the corresponding traveler charge card transaction; and
automatically reimbursing said corporate charge card provider from a corporate banking provider for said traveler charge card transaction.

20. A computer programmed to execute global travel reporting, the computer having the program performing the sequence, comprising:
downloading traveler charge card transaction data from a central database server system to create an expense book, said traveler charge card transaction data obtained by said central database server system directly from a corporate charge card provider and having currency data for application to the corresponding traveler charge card transaction; and
automatically reimbursing said corporate charge card provider from a corporate banking provider for said traveler charge card transaction.

21. Computer-readable media tangibly embodying an interface program of instructions executable by the machine to provide a graphical user interface to a computer program for global travel reporting, the interface program of instructions embodied in computer-readable media performing the sequence, comprising:
displaying icons and questions on the visual display unit at a traveler client system; and
obtaining data from the traveler, in response to said displaying, and providing the traveler data to the computer program, where the computer program, based on said traveler data, includes downloading traveler charge card transaction data from a central database server system to create an expense book, said traveler charge card transaction data obtained by said central database server system directly from a corporate charge card provider and having currency data for application to the corresponding traveler charge card transaction and reimbursing automatically said corporate charge card provider from a corporate banking provider for said traveler charge card transaction.
